(19) United States
(12) Patent Application Publication
(10) Pub. No.: US 2017/0028880 A1
(43) Pub. Date: Feb. 2, 2017

(54) TETHER ANCHOR BRACKET

(71) Applicant: TS TECH CO., LTD., Asaka-shi, Saitama (JP)

(72) Inventor: Teppei Ito, Tochigi (JP)

(21) Appl. No.: 15/303,667

(22) PCT Filed: Apr. 16, 2015
(86) PCT No.: PCT/JP2015/061750

§ 371 Date: Oct. 12, 2016

(30) Foreign Application Priority Data
Apr. 18, 2014 (JP) 2014-086581

(51) Int. Cl. B60N 2/28; B60N 2/68

(52) U.S. Cl. CPC B60N 2/2809; B60N 2/686

(57) ABSTRACT

The present disclosure describes a tether anchor bracket which can effectively prevent a tether anchor from being deformed when an impact load is applied. Deformable portions are formed at the tether anchor bracket to which an anchor to be engaged with a tether hook is fixed, the deformable portions being configured to be easily deformed compared with other portions, when an impact force is applied to the anchor.

### CROSS REFERENCE TO RELATED APPLICATIONS

This application is a National Stage Entry application of PCT Application No. PCT/JP2015/061750, filed Apr. 16, 2015, which claims the priority benefit of Japanese Patent Application No. 2014-086581, filed Apr. 18, 2014, the contents being incorporated herein by reference.

### BACKGROUND

This invention relates to a tether anchor bracket for fixing a child safety seat or the like to a seat, and particularly to a tether anchor bracket which is prevented from being deformed when a load is applied to a seating seat mounted within a vehicle.

A child safety seat on which a child is to be seated may be mounted on a vehicle seat. Such a child safety seat is fixed in such a way that for example, a seating portion (a vehicle lower portion) thereof is fixed by a seat belt to a main body of the vehicle seat and that a belt with one end fixed to a rear surface portion of the child safety seat is pulled toward a rear surface of the vehicle seat in a state where a tether hook provided at the other end of the belt is locked to a tether anchor arranged on the rear surface of the vehicle seat or the like. Thus, various techniques in each of which a tether anchor for locking a tether hook is attached to a vehicle body have been provided, for example, in Japanese Patent Publication JP 5109465B and Japanese Patent Publication JP 2011-121472A.

As conventional techniques, for example, Japanese Patent Publication JP 5109465B discloses the technique related to an anchor housing unit. Likewise, Japanese Patent Publication JP 2011-121472A discloses a tether anchor cover to which a tether anchor is attached.

### SUMMARY

As described above, according to the conventional techniques, the child safety seat can be fixed to the vehicle seat. In such conventional techniques, the tether anchor can be fixed to a tether anchor bracket. The development of a technique to, when an impact load is applied to the vehicle seat, prevent the tether anchor from being deformed by the impact load has been desired.

The present disclosure is made in view of the above-mentioned problem. An embodiment of the present disclosure provides a tether anchor bracket which can effectively prevent a tether anchor from being deformed when an impact load is applied.

The aforementioned problem is solved by an embodiment of a tether anchor bracket of the present disclosure to which an anchor to be engaged with a tether hook is fixed, the tether anchor bracket including a deformable portion configured to be easily deformed by an impact force which is applied to the anchor, compared with other portions.

For example, in a case where a strong impact force due to a collision or the like is applied to the tether hook, this impact force is directly transmitted to the anchor engaged with the tether hook. However, according to an embodiment of the present disclosure, in this case, the deformable portion is deformed; thereby, the impact force can be absorbed. As a result, the anchor itself can be prevented from being deformed.

Further, in an embodiment, the tether anchor bracket includes a main body to which the anchor is fixed and an extended portion which is extended from the main body. It is preferable that the extended portion includes: a fixed member attachment portion which is fixed to a fixed member; and a deformable portion which is a bent portion located between the main body and the fixed member attachment portion to be bent toward a vehicle rear side. As just described, the deformable portion is configured as the bent portion in the present disclosure; therefore, this bent portion can be more effectively deformed. In addition, the deformable portion may be formed in any manner as long as it is easily deformable. As an example, the deformable portion may be configured to have a small thickness, thereby being easily deformable. Also, the deformable portion may be provided with a slit, thereby being easily deformable. When being formed as the bent portion, preferably, the deformable portion can be easily manufactured and can effectively absorb an impact force to be deformed.

Further, in an embodiment, the deformable portion is configured to include at least one of a rearward bent portion bent to be protruded toward a vehicle rear side and a forward bent portion bent to be protruded toward a vehicle front side. In addition, it is preferable that the rearward bent portion is arranged adjacent to the main body and that the forward bent portion is formed between the rearward bent portion and the fixed member attachment portion. With the structure just described, in a case where an impact load is applied, the deformable portion can be more effectively deformed.

Moreover, in an embodiment, the deformable portion includes a plurality of deformable portions relative to the main body, the deformable portions being extended at least individually toward a vehicle upper side and a vehicle lower side relative to the main body, respectively, and that the deformable portions are configured by a first deformable portion which is formed between the fixed member attachment portion formed at the upper side and the main body and by a second deformable portion which is formed between the fixed member attachment portion formed at the lower side and the main body. With the structure just described, the plural deformable portions can be firmly fixed to the fixed member (for example, a seat back plate configuring a frame for a vehicle seat, or the like). In addition, in a case where an impact load is applied, the deformable portions can be more effectively deformed.

Further, in an embodiment, a deformation subsidiary portion is formed in the forward bent portion and that a portion where the deformation subsidiary portion is formed is configured to be more easily deformed than other portion of the forward bent portion. The deformation subsidiary portion is preferably a hole formed in the forward bent portion. With the structure just described, in a case where an impact load is applied, the deformable portion can be more easily deformed.

Furthermore, the deformation subsidiary portion may be formed in any manner as long as it is easily deformable. As an example, the deformation subsidiary portion may be configured to have a small thickness, thereby being easily deformable. Alternatively, in an embodiment, the deformation subsidiary portion can effectively promote the deformation when being formed as a hole.

In addition, the extended portion where the deformable portion is formed includes a plurality of extended portions relative to the main body, and preferably, a right-to-left width of the deformable portion provided in one location at a short distance to a position of the main body to which the anchor is attached is designed to be larger than a right-to-left width of the deformable portion provided in the other location at a long distance to the position of the main body to which the anchor is attached. With the structure just described, preferably, rigidity of a portion close to the attachment position of the anchor to which an impact load is often applied is further increased while deformability can be effectively performed.

The tether anchor bracket according to an embodiment of the present disclosure can absorb an impact force by the deformation of the deformable portion and can effectively prevent the anchor itself from being deformed. Further, the bent portion serving as the deformable portion can be more effectively deformed. Furthermore, when an impact load is applied, the deformable portion can be more effectively deformed. Still further, in the tether anchor bracket according to the present disclosure, the plural deformable portions can be firmly fixed to the fixed member (for example, a seat back plate configuring a frame for a vehicle seat, or the like), and in addition, the deformable portions can be effectively deformed. Further, with the tether anchor bracket according to the present disclosure, in case where an impact load is applied, the deformable portions can be more easily deformed. Moreover, with the tether anchor bracket according to the present disclosure, the rigidity of the portion close to the attachment position of the anchor is further increased, and in addition, the deformability can be effectively performed.

### BRIEF DESCRIPTION OF DRAWINGS

Various embodiments of the invention are illustrated in the drawings, in which:

FIG. 1 is a perspective view illustrating a seat frame to which a tether anchor bracket according to an embodiment of the present disclosure is attached;

FIG. 2 is a perspective view of the tether anchor bracket according to the embodiment of the present disclosure;

FIG. 3 is a rear view of the tether anchor bracket according to the embodiment of the present disclosure;

FIG. 4 is a front view of the tether anchor bracket according to the embodiment of the present disclosure;

FIG. 5 is a side view of the tether anchor bracket according to the embodiment of the present disclosure;

FIG. 6 is an explanatory drawing illustrating a function of the tether anchor bracket according to the embodiment of the present disclosure; and

FIG. 7A, FIG. 7B, and FIG. 7C are explanatory drawings illustrating variations of a reinforcement structure for a seat back frame according to the embodiment of the present disclosure.

### DETAILED DESCRIPTION

Herein, a tether anchor bracket according to an embodiment of the present disclosure (hereinafter referred to as the present embodiment) is described with reference to the drawings. In addition, the embodiment described below is merely an example indicating the application of the present disclosure, and it does not restrict the present disclosure. In other words, shapes, dimensions, arrangements, or the like of members described below may be modified or changed without departing from the scope of the present disclosure, and it is understood that the present disclosure may include its equivalents.

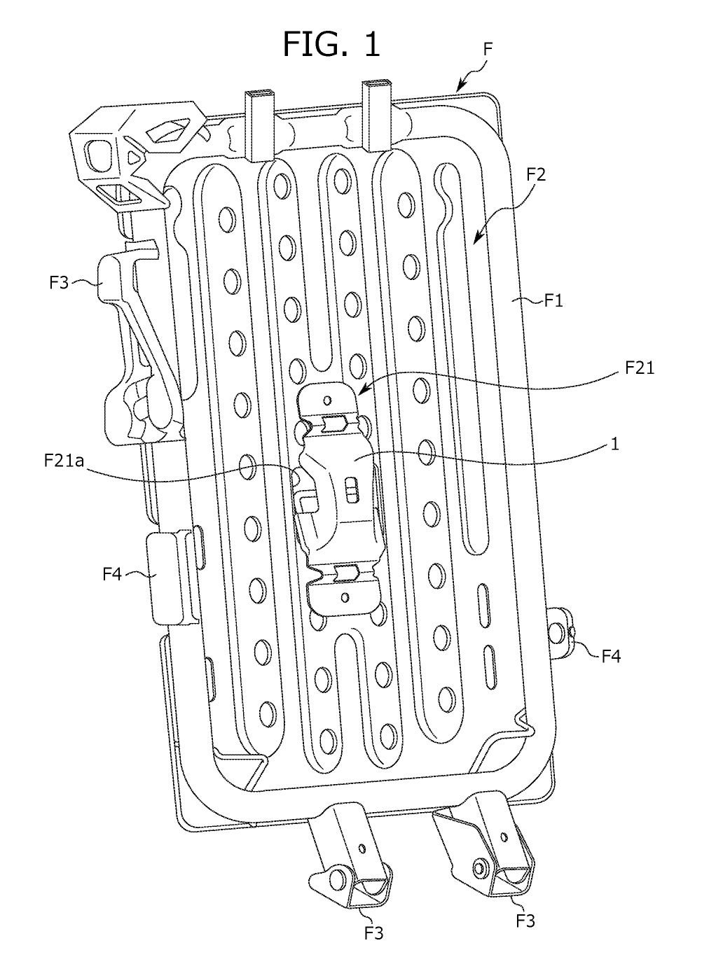

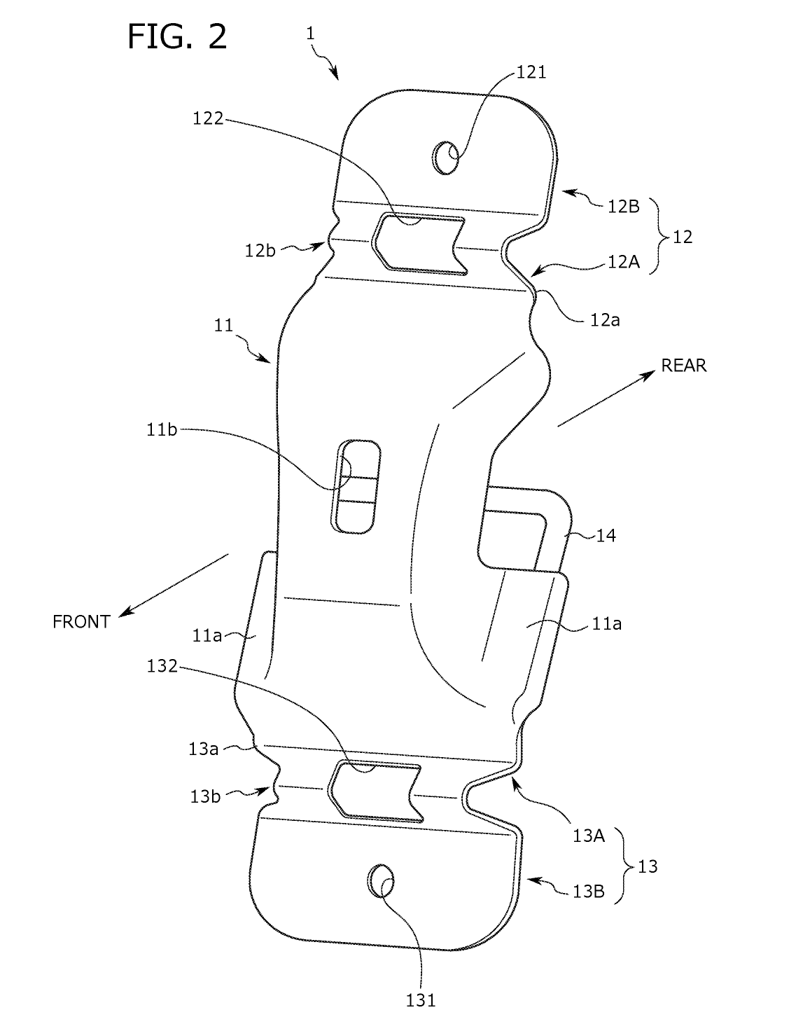

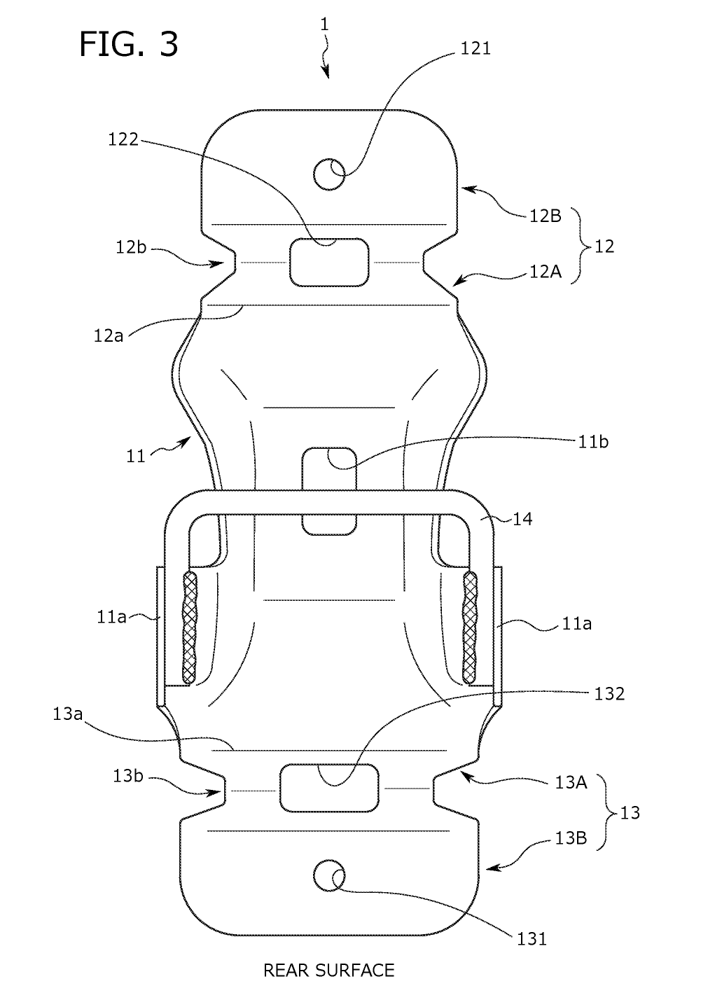

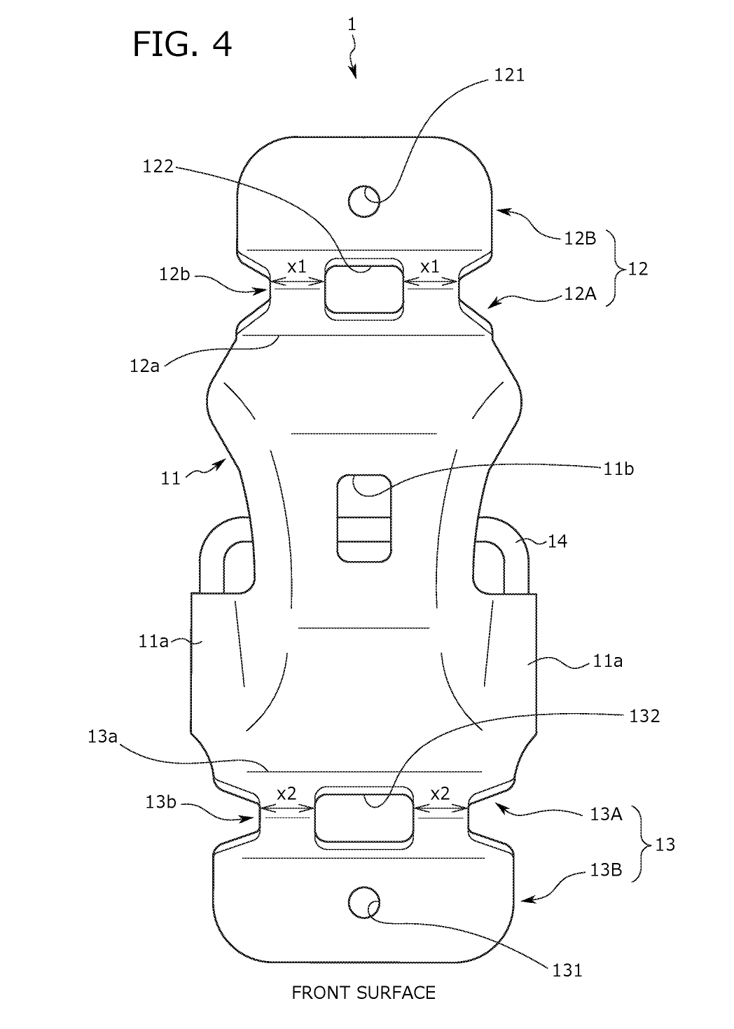

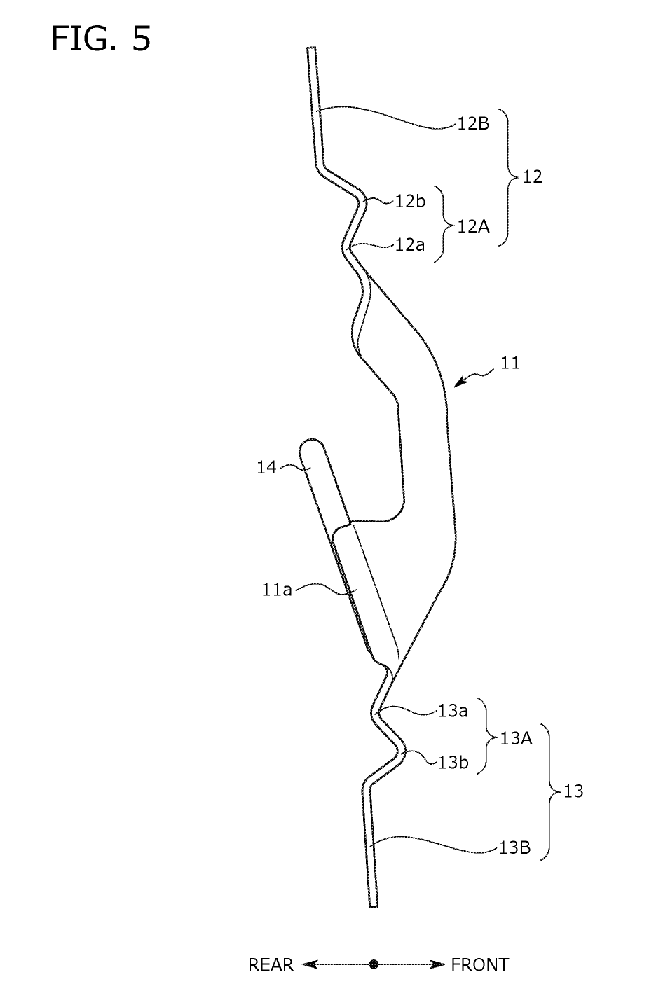

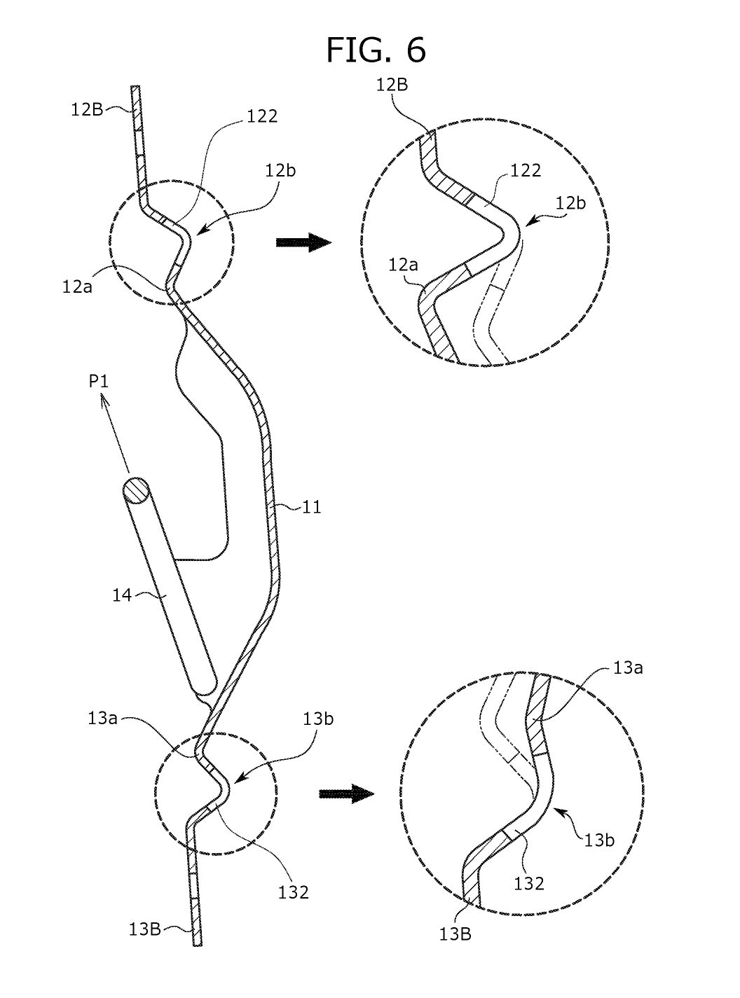

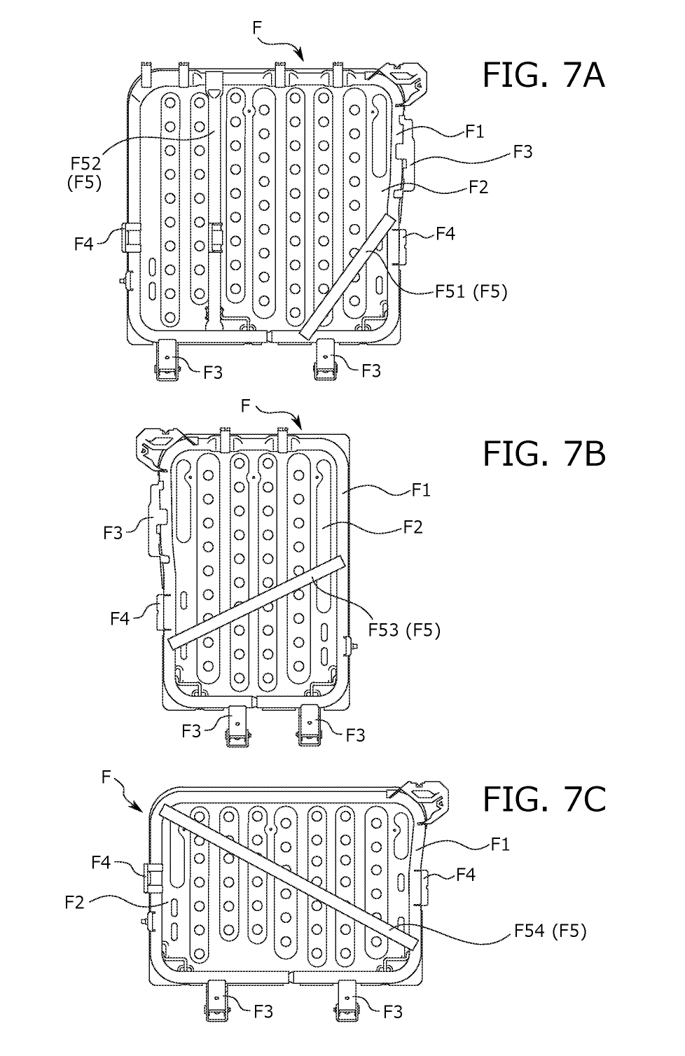

FIG. 1 to FIG. 6, FIG. 7A, FIG. 7B, and FIG. 7C illustrate an embodiment of the present disclosure. FIG. 1 is a perspective view illustrating a seat frame to which a tether anchor bracket is attached. FIG. 2 is a perspective view of the tether anchor bracket. FIG. 3 is a rear view of the tether anchor bracket. FIG. 4 is a front view of the tether anchor bracket. FIG. 5 is a side view of the tether anchor bracket. FIG. 6 is an explanatory drawing illustrating a function of the tether anchor bracket. FIG. 7A, FIG. 7B, and FIG. 7C are explanatory drawings illustrating variations of a reinforcement structure for a seat back frame.

Further, in the description below, the front to back direction of a vehicle means the front to back direction during normal travelling of the vehicle. Furthermore, the inner side of the vehicle (hereinafter simply referred to as the inner side) means the vehicle interior (indoor of the vehicle) while the outer side of the vehicle (hereinafter simply referred to as the outer side) means the vehicle exterior. Moreover, in the description below, the upper side or the lower side mean the upper side or the lower side, respectively, in an assembled state relative to a vehicle body.

Hereinafter, an example in which the tether anchor bracket is applied to a rear surface of a rear seat for a vehicle is indicated as an example of the application of the tether anchor bracket according to the present embodiment, but other embodiments are not limited thereto. The tether anchor bracket may be attached in any manner without departing from the scope of the invention.

FIG. 1 illustrates an attached state of a tether anchor bracket 1. In the present embodiment of FIG. 1, an example is shown in which the tether anchor bracket 1 is attached to a rear surface of a seat back frame F serving as a frame of a vehicle rear seat. The seat back frame F is used as the frame of the vehicle rear seat according to the present embodiment.

This seat back frame F is configured by having a seat back pipe F1 which defines an outer periphery of a rectangular shape, a rectangular flat plate-shaped seat back plate F2 which is arranged to fill the inside of this seat back pipe F1, vehicle body attachment portions F3, seat cushion connection portions F4, and a reinforcement member F5. In the example described here, a pipe is bent into a rectangular frame body, thereby forming the seat back pipe F1.

Further, the seat back plate F2 is a rectangular flat plate in which plural holes are created. The seat back plate F2 is arranged to fill a rectangular inner space formed by the seat back pipe. Furthermore, the vehicle body attachment portions F3 are respectively arranged in a protruding manner at both ends on the lower side of the seat back pipe F1, and the single vehicle body attachment portion F3 is arranged in a protruding manner at an upper portion on one of the right and left sides of the seat back pipe. Furthermore, one of the seat cushion connection portions F4 is arranged in a protruding manner below the vehicle body attachment portion F3 arranged at the upper portion on one of the right and left sides of the seat back pipe while the other one of the seat cushion connection portions F4 is arranged in a protruding manner at a lower portion on the other of the right and left sides of the seat back pipe.

Further, the reinforcement member F5 is arranged to be bridged between the sides of the seat back pipe F1, thereby reinforcing rigidity of the seat back frame F. For example, the reinforcement member F5 is arranged to be connected obliquely extending across an inner corner section which is formed by a lower portion of one of the right and left sides of the seat back pipe and by the lower side of the seat back pipe, thereby reinforcing the rigidity of the seat back frame F. Furthermore, there are many variations of the arrangement structure of the reinforcement member F5; therefore, the detail thereof is described below. In addition, a bracket attachment portion F21 is formed near the center of the seat back plate F2. Moreover, an anchor arrangement hole F21a is formed in this bracket attachment portion F21. As further described in detail below, the tether anchor bracket 1 is arranged to cover this anchor arrangement hole F21a from the front of the seat back plate F2. In addition, in such arrangement state, an anchor 14 is exposed through the anchor arrangement hole F21a to a rear surface of the seat back plate F2. Thus, a top tether hook (not shown) is located on the rear of the seat back plate F2 to be engageable with the anchor 14.

The structure of the tether anchor bracket 1 is now described. As shown in FIG. 2 to FIG. 5, the tether anchor bracket 1 according to the present embodiment is configured by having a main body 11, a first extended portion 12, a second extended portion 13, and the anchor 14. The main body 11 is a portion shaped of a housing having a bottom. Anchor supporting portions 11a, 11a are respectively formed on both sides at the lower side of the housing. This anchor supporting portion 11a is a rod-shaped recessed groove. An end of the anchor 14 described below is fixed to the anchor supporting portion 11a by welding or the like while being fitted into the groove. Moreover, a rectangular perforated main body hole 11b is formed near the center of the main body 11. In addition, welding positions of the both ends of the anchor 14 are positions indicated by shaded areas in FIG. 3. That is, the welding positions of the both ends of the anchor 14 to the anchor supporting portions 11a, 11a are provided at the inner side of the main body 11 in the width direction. With the structure just described, the tether anchor bracket 1 can be prevented from increasing in size.

Further, the first extended portion 12 is a portion extended from an upper portion of the main body 11. The first extended portion 12 is configured by having a first connection portion 12A and a first plate attachment portion 12B. The first connection portion 12A is extended rearward from an upper end of the main body 11 to be subsequently bent forward and further rearward.

That is, the first connection portion 12A is bent to make a protrusion at the rear side and another protrusion at the front side. In addition, the first plate attachment portion 12B of a rectangular shape is extended upward from an upper end of the first connection portion 12A. A first fastening member arrangement hole 121 for attaching the first plate attachment portion 12B to the seat back plate F2 is formed near the center of this first plate attachment portion 12B.

Herein, a bent portion located adjacent to the main body 11 and protruded rearward is indicated as “a first rearward bent portion 12a”, and a bent portion formed to be separated from the main body 11 and protruded forward is indicated as “a first forward bent portion 12b”. In addition, a first bending subsidiary portion 122 which is a rectangular hole is formed near the center of this first forward bent portion 12b.

Further, this first bending subsidiary portion 122 is formed at the bent portion of the first forward bent portion 12b that is provided in a position separated from the positions to which the anchor 14 is welded, compared with the first rearward bent portion 12a. Therefore, the tether anchor bracket can be more easily deformed without influence which may reduce rigidity of the main body 11 to which the anchor 14 is attached. This first bending subsidiary portion 122 has a function to allow the tether anchor bracket 1 to deform when an impact load is applied and to prevent deformation of the anchor 14 to which the top tether hook (not shown) is fixed. This structure is a main structure of the first bending subsidiary portion and therefore is described in detail below.

Furthermore, the second extended portion 13 is a portion extended from a lower portion of the main body 11. The second extended portion 13 is configured by having a second connection portion 13A and a second plate attachment portion 13B. The second connection portion 13A is extended rearward from a lower end of the main body 11 to be subsequently bent forward and further rearward. That is, the second connection portion 13A is bent to make a protrusion at the rear side and another protrusion at the front side. In addition, the second plate attachment portion 13B of a rectangular shape is extended downward from a lower end of the second connection portion 13A. A second fastening member arrangement hole 131 for attaching the second plate attachment portion 13B to the seat back plate F2 is formed near the center of this second plate attachment portion 13B.

Herein, a bent portion located adjacent to the main body 11 and protruded rearward is indicated as “a second rearward bent portion 3a”, and a bent portion formed to be separated from the main body 11 and protruded forward is indicated as “a second forward bent portion 13b”. In addition, a second bending subsidiary portion 132 which is a rectangular hole is formed near the center of this second forward bent portion 13b.

Further, this second bending subsidiary portion 132 is formed at the bent portion of the second forward bent portion 13b that is provided in a position separated from the positions to which the anchor 14 is welded, compared with the second rearward bent portion 13a. Therefore, the tether anchor bracket can be more easily deformed without influence which may reduce rigidity of the welding positions of the anchor 14. This second bending subsidiary portion 132 has a function to allow the tether anchor bracket 1 to deform when an impact load is applied and to prevent deformation of the anchor 14 to which the top tether hook (not shown) is fixed. This structure is a main structure of the second bending subsidiary portion and therefore is described in detail below.

Furthermore, in the example described here, the area of the second plate attachment portion 13B is designed to be larger than the area of the first plate attachment portion 12B. That is, the area of the second plate attachment portion 13B that is arranged adjacent to fixed portions of the anchor 14 is designed to be larger than the area of the first plate attachment portion 12B that is arranged to be separated from the fixed portions of the anchor 14. Therefore, fixation rigidity of a portion to which a load is applied can be increased.

Moreover, the width of the main body 11 in the horizontal direction is designed to be larger than the widths of the first rearward bent portion 12a and the second rearward bent portion 13a in the horizontal direction, and in addition, the width of the main body 11 in the horizontal direction is designed to be larger than the widths of the first forward bent portion 12b and the second forward bent portion 13b in the horizontal direction. In particular, the width between the anchor supporting portions 11a, 11a in the horizontal direction, which are formed on the both sides at the lower side of the main body 11, is designed to be large; thereby, rigidity of the positions to which the both ends of the anchor 14 are welded is increased.

With the structure just described, in a normal condition, the anchor 14 can be more stably held due to the large width of the main body 11 in the horizontal direction. In addition, in a case where an impact load is applied to the anchor 14, the first rearward bent portion 12a and the second rearward bent portion 13a, and the first forward bent portion 12b and the second forward bent portion 13b are easily deformed.

In addition, recessed portions recessed inward in the right to left direction (the vehicle width direction) are formed in the first connection portion 12A provided between the main body 11 and the first plate attachment portion 12B, and recessed portions recessed inward in the right to left direction (the vehicle width direction) are formed in the second connection portion 13A provided between the main body 11 and the second plate attachment portion 13B (in particular, see FIG. 4). In such case, in the present embodiment, in order that a distance x1 between a root tip of a cavity portion of one of the recessed portions of the first connection portion 12A and the first bending subsidiary portion 122 in the right to left direction (the vehicle width direction) is equal to a distance x2 between a root tip of a cavity portion of one of the recessed portions of the second connection portion 13A and the second bending subsidiary portion 132, depths of the both recessed portions (distances recessed inward in the right to left direction (the vehicle width direction)) and opening distances of the first bending subsidiary portion 122 and the second bending subsidiary portion 132 in the right to left direction (the vehicle width direction) are established. Thus, even in a case where the depths of the both recessed portions (the distances recessed inward in the right to left direction (the vehicle width direction)) are established to be equal to each other and in a case where the opening distances of the first bending subsidiary portion 122 and the second bending subsidiary portion 132 in the right to left direction (the vehicle width direction) are established to be equal to each other (even in a case where x1≠x2 is established), it is provided that rigidity of a portion to which a load is applied is well balanced with deformability of a portion which may be deformed and both the rigidity and the deformability are compatible with each other. Each size is established as described above; thereby, the rigidity of the portion to which a load is applied is more well-balanced with the deformability of the portion which may be deformed and both the rigidity and the deformability can be more compatible with each other. Moreover, in the present embodiment, the sizes of portions in the main body 11, the first plate attachment portion 12B, and the second plate attachment portion 13B are also established as described above. Even in a case where the sizes of the aforementioned portions are established so that the corresponding portions have the same size or the like, it is provided that rigidity of a portion to which a load is applied is well-balanced with deformability of a portion which may be deformed and both the rigidity and the deformability are compatible with each other. However, the sizes of the corresponding portions are established as described above; thereby, the rigidity of the portion to which a load is applied is more well-balanced with the deformability of the portion which may be deformed and the both the rigidity and the deformability can be more compatible with each other.

The tether anchor bracket 1 configured in this manner is arranged as described above to cover the anchor arrangement hole F21a formed in the seat back plate F2 from the front thereof. In this condition, the anchor 14 is exposed from the anchor arrangement hole F21a to the rear surface of the seat back plate F2. In addition, fastening members (not shown) are respectively fastened through the first fastening member arrangement hole 121 formed in the first plate attachment portion 12B and through the second fastening member arrangement hole 131 formed in the second plate attachment portion 13B; thereby, the tether anchor bracket 1 is attached to the seat back plate F2.

The functions of the first bending subsidiary portion 122 and the second bending subsidiary portion 132 are now described on the basis of FIG. 6. For example, in a case where an impact load is applied to cause the anchor 14 to be pulled by the top tether hook (not shown), an additional force P1 is applied. As described above, the second rearward bent portion 13a and the second forward bent portion 13b are formed at the second connection portion 13A. These bent portions are easily deformed, and the second plate attachment portion 13B located below the bent portions is fixed to the seat back plate F2.

Moreover, the second bending subsidiary portion 132 which is a rectangular hole is formed near the center of the second forward bent portion 13b, and the rectangular hole allows the bent portions to be more easily deformed. Therefore, when the additional force P1 is applied, the second rearward bent portion 13a is deformed so that its lower portion is pulled upward. In addition, the second forward bent portion 13b is deformed so that its upper portion is pulled upward from the second bending subsidiary portion 132 (the second rearward bent portion 13a and the second forward bent portion 13b are deformed to extend upward).

Further, the first rearward bent portion 12a and the first forward bent portion 12b are formed at the first connection portion 12A. These bent portions are easily deformed, and the first plate attachment portion 12B located above the bent portions is fixed to the seat back plate F2. Furthermore, the first bending subsidiary portion 122 which is a rectangular hole is formed near the center of the first forward bent portion 12b, and the rectangular hole allows the bent portions to be more easily deformed. Therefore, when the additional force P1 is applied, the first rearward bent portion 12a is deformed so that its lower portion is pulled upward. In addition, the first forward bent portion 12b is deformed to be crushed from the first bending subsidiary portion 122.

As described above, when the force P1 is applied, the first rearward bent portion 12a, the first forward bent portion 12b (the first bending subsidiary portion 122), the second rearward bent portion 13a, and the second forward bent portion 13b (the second bending subsidiary portion 132) are deformed; thereby, the additional force P1 is absorbed by this deformation. As a result, the first extended portion 12 and the second extended portion 13 (and the main body 11) are deformed; however, the anchor 14 is effectively prevented from being deformed.

Thus, the first forward bent portion 12b and the first rearward bent portion 12a are deformed particularly from the first bending subsidiary portion 122, and the second forward bent portion 13b and the second rearward bent portion 13a are deformed particularly from the second bending subsidiary portion 132. Therefore, the additional force P1 is absorbed and the anchor 14 itself can be effectively prevented from being deformed. Further, in the present embodiment, the first bending subsidiary portion 122 and the second bending subsidiary portion 132 are formed as the holes; therefore, these holes can be easily deformed and the additional force P 1 can be effectively absorbed.

Furthermore, in the present embodiment, the first bending subsidiary portion 122 and the second bending subsidiary portion 132 are formed as the rectangular holes; however, the shape of the hole is not limited thereto. The hole may be formed into any shape without departing from the scope of the present disclosure. In addition, in the present embodiment, the first forward bent portion 12b and the second forward bent portion 13b, and the first rearward bent portion 12a and the second rearward bent portion 13a are formed as the bent portions, but are not limited thereto, and they may be configured in any manner without departing from the scope of the present disclosure. For example, the forward bent portion corresponding to a fold line may be configured to have a small thickness without being bent or may be configured with a hole. Alternatively, an elastic body may be applied as the forward bent portion.

An embodiment of the reinforcement structure for the seat back plate F2 is now described on the basis of FIG. 7A, FIG. 7B, and FIG. 7C. For example, as shown in FIG. 7A, a reinforcement member F51 is arranged to be connected obliquely extending across the inner corner section that is formed by the lower portion of one of the right and left sides and by the lower side, thereby reinforcing the rigidity of the seat back frame F. In addition, a portion of the reinforcement member F51, which is connected to the lower portion of one of the right and left sides, is positioned between the vehicle body attachment portion F3 and the seat cushion connection portion F4 of the seat back frame F while a portion of the reinforcement member F51, which is connected on the lower side, is positioned between the two vehicle body attachment portions F3, F3. Further, a reinforcement member F52 may be arranged to be bridged between the upper side and the lower side. Furthermore, a different structure may be applied as shown in FIG. 7B such that a reinforcement member F53 is arranged obliquely (at a slight angle with respect to the horizontal direction) to be bridged between one and the other of the right and left sides of the seat back frame F. In addition, a portion of the reinforcement member F53, which is connected on one of the right and left sides, is positioned above the seat cushion connection portion F4 while a portion of the reinforcement member F53, which is connected on the other of the right and left sides, is positioned below the seat cushion connection portion F4. Moreover, as shown in FIG. 7C, a reinforcement member F54 may be arranged diagonally to connect diagonally opposite inner corners of the seat back pipe F1 that is formed into a rectangular frame shape. That is, the seat back pipe F1 is arranged around the outer periphery of the seat back plate F2 and the reinforcement member F54 is arranged on the seat back pipe F1 to be obliquely connected thereto.

TABLE OF REFERENCE NUMERALS

```
1: tether anchor bracket
  11: main body
    11a: anchor supporting portion
    11b: main body hole
  12: first extended portion
    12A: first connection portion (extended portion)
      12a: first rearward bent portion (deformable portion, first deformable
portion)
      12b: first forward bent portion (deformable portion, first deformable
portion)
        122: first bending subsidiary portion (deformation subsidiary
portion)
    12B: first plate attachment portion (fixed member attachment portion)
      121: first fastening member arrangement hole
  13: second extended portion
    13A: second connection portion (extended portion)
      13a: second rearward bent portion (deformable portion, second
deformable portion)
      13b: second forward bent portion (deformable portion, second
deformable portion)
        132: second bending subsidiary portion (deformation
subsidiary portion)
    13B: second plate attachment portion (fixed member attachment portion)
      131: second fastening member arrangement hole
  14: anchor
F: seat back frame
  F1: seat back pipe
  F2: seat back plate (fixed member)
    F21: bracket attachment portion
      F21a: anchor arrangement hole
  F3: vehicle body attachment portion
  F4: seat cushion connection portion
  F5 (F51 to F54): reinforcement member
```

1. A tether anchor bracket to which an anchor to be engaged with a tether hook is fixed, the tether anchor bracket comprising:
a deformable portion configured to be easily deformed by an impact force which is applied to the anchor, compared with other portions.

2. The tether anchor bracket according to claim 1, further comprising:
a main body to which the anchor is fixed; and
an extended portion extended from the main body, the extended portion
including a fixed member attachment portion, which is to be fixed to a fixed member, and a deformable portion, which is a bent portion located between the main body and the fixed member attachment portion to be bent toward a vehicle rear side.

3. The tether anchor bracket according to claim 2, wherein the deformable portion is configured to include at least one of a rearward bent portion bent to be protruded toward a vehicle rear side and a forward bent portion bent to be protruded toward a vehicle front side.

4. The tether anchor bracket according to claim 3, wherein the rearward bent portion is arranged adjacent to the main body, and the forward bent portion is formed between the rearward bent portion and the fixed member attachment portion.

5. The tether anchor bracket according to claim 4, wherein the deformable portion comprises a plurality of deformable portions that are deformable relative to the main body, the deformable portions being extended at least individually toward a vehicle upper side and a vehicle lower side relative to the main body, respectively, the deformable portions being configured to include i) a first deformable portion which is formed between the fixed member attachment portion formed at the upper side and the main body and ii) a second deformable portion which is formed between the fixed member attachment portion formed at the lower side and the main body.

6. The tether anchor bracket according to claim 3, wherein a deformation subsidiary portion is formed in the forward bent portion, and a portion where the deformation subsidiary portion is formed is configured to be more easily deformed than other portions of the forward bent portion.

7. The tether anchor bracket according to claim 6, wherein the deformation subsidiary portion is a hole formed in the forward bent portion.

8. The tether anchor bracket according to claim 2,
wherein the extended portion where the deformable portion is formed comprises a plurality of extended portions that are extended relative to the main body, and
wherein a width in a right to left direction of the deformable portion provided in a first location at a first distance to a position of the main body to which the anchor is attached is designed to be larger than a width in the right to left direction of the deformable portion provided in a second location at a second distance to the position of the main body to which the anchor is attached, where the first distance is shorter than the second distance.
